(19) United States
(12) Patent Application Publication
(10) Pub. No.: US 2025/0377470 A1
(43) Pub. Date: Dec. 11, 2025

(54) TREMOR CHARACTERIZATION FOR GEOTHERMAL IMAGING

(71) Applicant: Zanskar Geothermal & Minerals, Inc., Salt Lake City, UT (US)

(72) Inventors: Joel EDWARDS, Murray, UT (US); Sean MAHER, Salt Lake City, UT (US); Carl HOILAND, Provo, UT (US); Hao ZHANG, Sandy, UT (US)

(21) Appl. No.: 18/738,871

(22) Filed: Jun. 10, 2024

(51) Int. Cl. G01V 1/30; G01V 1/28

(52) U.S. Cl. CPC G01V 1/301; G01V 1/282; G01V 2210/1299; G01V 2210/32

(57) ABSTRACT

The described techniques relate to an improved method for geothermal imaging. The method may include obtaining raw seismic data from seismic receivers distributed with reference to a geological zone and detecting a tremor event from the raw seismic data. The detecting may include generating processed seismic data from the raw seismic data; generating spectral representations; generating, for pairs of seismic receivers, a covariance matrix including a cross-spectra between pairs of the spectral representations; generating a time-frequency representation of the processed seismic data; fitting synthetic resonance spectra to the time-frequency representation of the processed seismic data on a per-time-instance basis; and identifying a subset of the processed seismic data based on the fitting, where the subset of the processed seismic data is representative of the tremor event. After detecting the tremor event, method may include outputting candidate locations representative of a source of the tremor event.

### FIELD OF TECHNOLOGY

The present disclosure relates generally to tremor characterization for geothermal reservoir imaging, and more specifically to tremor event detection and candidate location identification for a source of the detected tremor event.

### BACKGROUND

Tremor events may be observed at many sources of geothermal energy, such as volcanoes, hydrothermal systems, hot sedimentary basins, recently active fault zones, or the like. Tremor events may be characterized by a long duration and a low frequency relative to other seismic activities, such as earthquakes. Because tremor events often emerge gradually from background noise, tremor events may not have a distinct arrival time. Accordingly, tremor events may be difficult to detect or locate.

### SUMMARY

The described techniques relate to improved methods, systems, devices, and apparatuses that support tremor characterization for geothermal imaging. Generally, the described techniques provide for obtaining raw seismic data from seismic receivers distributed with reference to a geological zone. After obtaining the raw seismic data, the described techniques provide for detecting a tremor event from the raw seismic data. The detecting may include generating processed seismic data from the raw seismic data; generating spectral representations based on the raw seismic data or the processed seismic data; generating, for respective pairs of seismic receivers, a covariance matrix including cross-spectra between respective pairs of the spectral representations; generating a time-frequency representation of the processed seismic data based on a sum of covariance matrix; fitting synthetic resonance spectra to the time-frequency representation of the processed seismic data on a per-time-instance basis; and identifying a subset of the processed seismic data based on the fitting, where the subset of the processed seismic data is representative of the tremor event. After detecting the tremor event, the described techniques below provide for outputting candidate locations representative of a source of the tremor event.

### BRIEF DESCRIPTION OF THE DRAWINGS

FIG. 1 shows an example of a geological zone with seismic receivers that supports tremor characterization for geothermal imaging in accordance with aspects of the present disclosure.

FIGS. 2 through 6 show examples of flow diagrams that supports tremor characterization for geothermal imaging in accordance with aspects of the present disclosure.

FIG. 7 shows a block diagram of an action response component that supports tremor characterization for geothermal imaging in accordance with aspects of the present disclosure.

FIG. 8 shows a diagram of a system including a device that supports tremor characterization for geothermal imaging in accordance with aspects of the present disclosure.

FIG. 9 shows a flowchart illustrating methods that support tremor characterization for geothermal imaging in accordance with aspects of the present disclosure.

### DETAILED DESCRIPTION

Exploration and development of geothermal resources for energy production may be associated with high risk relative to other energy sources. Specifically, identification of permeable subsurface pathways may be challenging due to uncertainties related to geophysical imaging techniques. A type of seismic signal, such as a tremor event, may provide a direct indication of fluid movement through permeable subsurface fractures. However, these tremor events may be more difficult to detect and locate than typical earthquakes because the tremor events lack distinct arrival times and emerge gradually from background noise. Accordingly, one or more aspects of the present disclosure provide for improved techniques for detecting tremor events and identifying associated source locations. Such techniques may be utilized to reduce the exploration risk associated with geothermal energy.

As described herein, a method of tremor characterization for geothermal imaging may include data processing, tremor event detection, and tremor event source identification. For example, the method may include obtaining raw seismic data from seismic receivers distributed with reference to a geological zone and detecting a tremor event from the raw seismic data. The detecting may include generating processed seismic data from the raw seismic data; generating spectral representations; generating, for pairs of seismic receivers, a covariance matrix including cross-spectra between pairs of the spectral representations; generating a time-frequency representation of the processed seismic data; fitting synthetic resonance spectra to the time-frequency representation of the processed seismic data on a per-time-instance basis; and identifying a subset of the processed seismic data based on the fitting, where the subset of the processed seismic data is representative of the tremor event. After detecting the tremor event, a method may include outputting candidate locations representative of a source of the tremor event.

Aspects of the disclosure are initially illustrated by and described with reference to an exemplary geological zone with seismic receivers. Aspects of the disclosure are also described with reference to flow diagrams. Aspects of the disclosure are further illustrated by and described with reference to apparatus diagrams, system diagrams, and flowcharts that relate to tremor characterization for geothermal imaging.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system to solve other problems additionally or alternatively from those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

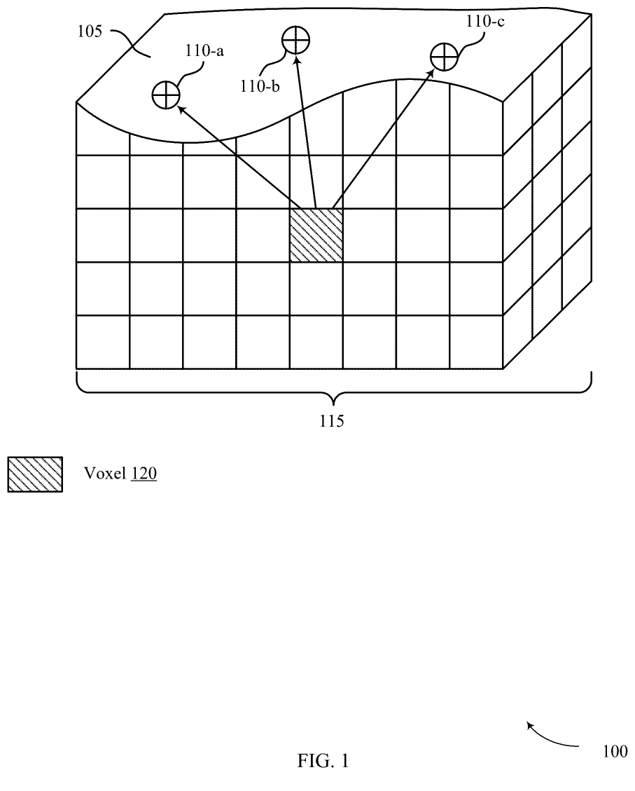

FIG. 1 shows an example of a geological zone 100 that supports tremor characterization for geothermal imaging in accordance with aspects of the present disclosure. The geological zone 100 may include a surface 105 and a network or array of one or more receivers, such as a receiver 115-a, a receiver 115-b, and a receiver 115-c. While three receivers are illustrated in the example of FIG. 1, it may be understood that the geological zone 100 may include fewer or greater than three receivers. Additionally, the geological zone 100 may include a three-dimensional area 115 beneath the surface 105. The three-dimensional area 115 may be subdivided into voxels. For example, the three-dimensional area 115 may include multiple voxels, including a voxel 120, which a tremor characterization system may use as a reference point for seismic wave propagation. That is, the tremor characterization system may measure a seismic wave propagating between one or more of the receivers and the voxels of the three-dimensional area 115.

In some examples, the receivers 110 may be referred to as seismic receivers or seismic stations. The receivers 110 may receive and store (e.g., collect) raw seismic data. The receivers may include one or more measurement components (e.g., an inertial-mass geophone, piezoelectric accelerometer or hydrophone), a digitizer, one or more data storage components, a power source, or any combination thereof. Additionally, or alternatively, the geological zone 100 may include a distributed acoustic sensing (DAS) system or interrogator. The DAS system may include fiber optic cable, which may sense and measure the raw seismic data. For example, the DAS system may sense and measure the raw seismic data based on light transmitted from the interrogator through the fiber optic cable and backscattered light (e.g., Rayleigh backscatter).

The receivers 110 may be a component of a tremor characterization system. For example, the tremor characterization system detects tremor events and identifies locations of sources of the tremor events. Tremor events may be associated with a long duration and low frequency relative to other seismic events, such as earthquakes. For example, tremor events may have a duration ranging from minutes (e.g., more than 2 minutes) to years, and may have a fundamental frequency of 1 to 20 Hz. Additionally, tremor events may include distinct spectral peaks that may change over time and waves (e.g., body waves and/or surface waves) which do not have distinct arrival times. In other words, tremor events may have an emergent onset. In some examples, emergent onset of tremor events and lack of distinct arrival times of waves used to identify seismic events, such as P waves and S waves, may be associated with difficulties in tremor detection and source location.

Tremor events may be associated with a source. Tremor events may have natural sources, including resonance of fluid-filled cracks, pressure variations induced by fluid flow, overlapping shear failure earthquakes, or slow fault slip; artificially-induced natural sources, such as enhanced geothermal operations or production or injection wells; or artificial sources, such as trains, planes, or pumps. For example, a source of a tremor event may be understood as a location within the geological zone 100 from which the tremor event is determined to originate.

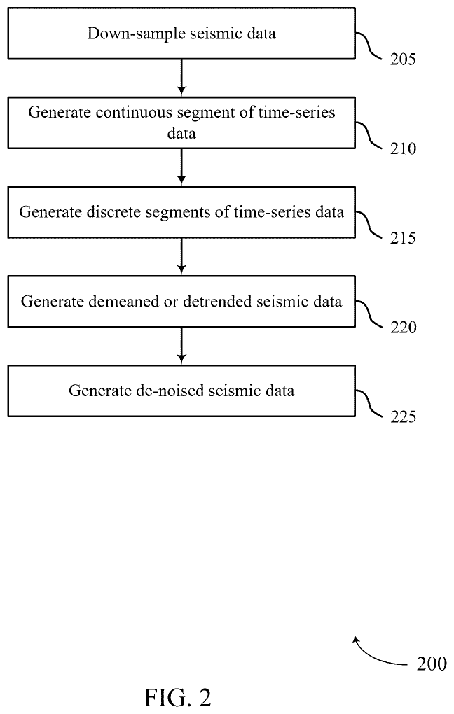

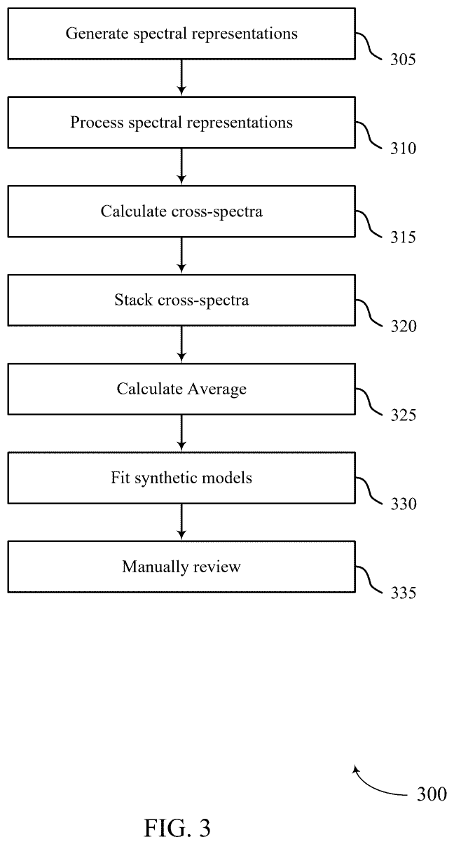

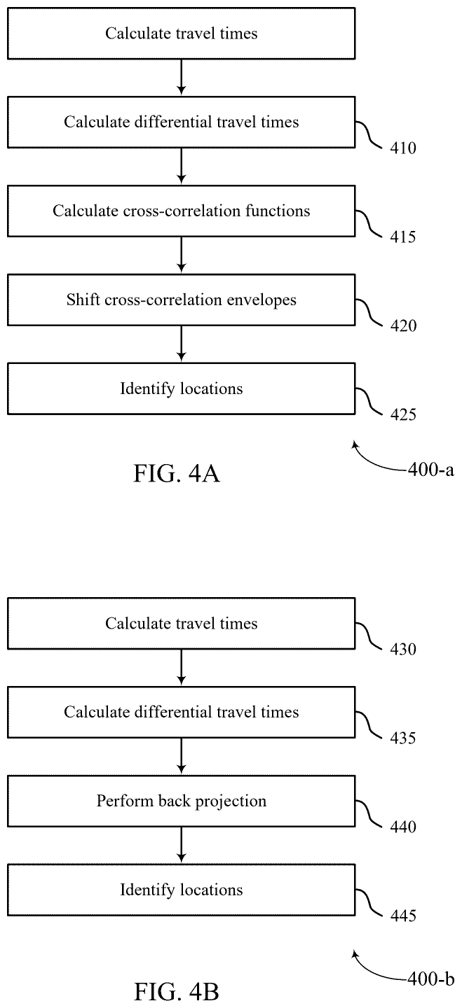

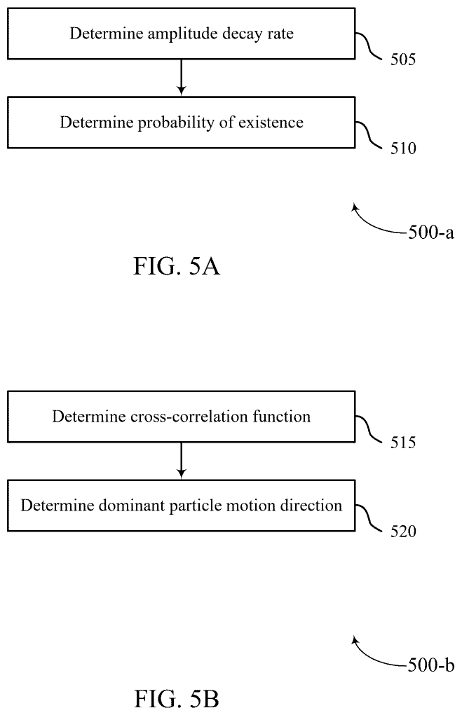

The tremor characterization system may process raw seismic data collected from the receivers 110, detect tremor events, identify source locations, or any combination thereof. The processing, detection, and location identification methods may be described in greater detail elsewhere herein. For example, raw seismic data processing may be described in greater detail with reference to FIG. 2, tremor detection may be described in greater detail with reference to FIG. 3, and location identification may be described in greater detail with reference to FIGS. 4 and 5.

In some examples, the tremor characterization system may detect tremor events and identify source locations of the tremor events to plan drilling locations of geothermal wells, to improve geothermal wellfield design, or to update models of a subsurface reservoir. For example, the tremor characterization system may be used to improve efficiency associated with geothermal power plant construction.

FIG. 2 shows an example of a flow diagram 200 that supports tremor characterization for geothermal imaging in accordance with aspects of the present disclosure. The flow diagram 200 may implement or be implemented by various aspects of the geological zone 100. For example, the flow diagram 200 may represent processing of raw seismic data by a tremor characterization system, where the raw seismic data may be collected from multiple receivers, such as the receivers 110 as described with reference to FIG. 1.

The tremor characterization system may perform one or more processing operations on the raw seismic data. For example, the tremor characterization system may perform one or more processing operations prior to performing tremor detection, source location identification, or both. As described herein, the processing of the raw seismic data may be referred to as pre-processing. Some operations of the flow diagram may be performed in a different order than described or not performed at all. In some examples, operations may include additional features not mentioned below, or further operations may be added.

At 205, the tremor characterization system may down-sample seismic data. For example, the tremor characterization system may down-sample the raw seismic data obtained (e.g., collected) by multiple receivers distributed with reference to a geological area, such as the geological zone 100 as described with reference to FIG. 1. In some examples, the tremor characterization system may down-sample the seismic data in accordance with a down-sampling ratio. For example, the tremor characterization system may down-sample the seismic data to ⅓ of an original sampling rate.

At 210, the tremor characterization system may generate a continuous segment of time-series data. For example, the tremor characterization system may convert the down-sampled seismic data into a format (e.g., MiniSeed or seismic analysis code (SAC)). The format may include a single, contiguous segment of time-series data structured as a header section followed by floating point data values. In other words, the tremor characterization system may generate a continuous segment of time-series data based on the down-sampled seismic data. In some examples, the tremor characterization system may generate continuous segments of time-series data for the receivers.

At 215, the tremor characterization system may generate discrete segments of time-series data. For example, the tremor characterization system may cut (e.g., portion, divide, etc.) the continuous segment of time-series data into discrete segments. In other words, the tremor characterization system may generate multiple discrete segments of the time-series data from the continuous segment of the time-series data. In such as examples in which the tremor characterization system generates the continuous segments of time-series data for the receivers, respective receivers may be associated with respective discrete segments of the time-series data.

At 220, the tremor characterization system may generate demeaned or detrended seismic data. For example, the tremor characterization system may subtract a sample mean from the discrete segments of the time-series data, remove an effect of a trend from the discrete segments of the time-series data, or both. In other words, the tremor characterization system may generate demeaned or detrended seismic data for each of the multiple discrete segments based on removal of a mean, a linear trend, or both from each of the multiple discrete segments.

At 225, the tremor characterization system may generate de-noised seismic data. For example, the tremor characterization system may bandpass filter data into a relatively narrow frequency band (e.g., 0.2 to 5 Hz) centered at a frequency (e.g., between 0.1 and 25 Hz). Additionally, or alternatively, the tremor characterization system may decimate the filtered data to a sample rate between a frequency range (e.g., 50 to 100 Hz). In some examples, the tremor characterization system may normalize the discrete segments of the time-series data according to a power associated with each respective discrete segment. In other words, the tremor characterization system may generate processed seismic data based on applying at least one of a bandpass filter, decimation, normalization, or any combination thereof, to the demeaned or detrended seismic data generated at 220. Additionally, or alternatively, the tremor characterization system may calculate a travel time lookup table from the receivers to multiple points of the geological zone, such as multiple voxels. For example, the tremor characterization system may generate the travel time lookup table based on a velocity model, such as a velocity model associated with velocities of P waves, velocities of S waves, velocities of surface waves, or any combination thereof.

In some examples, the tremor characterization system may perform the processing in accordance with seismic data collected from a DAS system. That is, in examples in which the raw seismic data is collected via a DAS system, the tremor characterization system may perform a processing operation in accordance with the DAS system. The processing operation associated with the DAS system may include loading the raw seismic data (e.g., raw DAS recordings), which may, in some examples, be associated with one or more different formats (e.g., hierarchical data format version 5 (HDF5), Society of Exploration Geophysics—Format D (SEGD), SEG—Format Y (SEGY), binary, MAT, SAC, MiniSeed, etc.). After loading the raw seismic data, the processing operation may include plotting and analyzing the raw seismic data in a time domain and in a frequency domain (i.e., spectral analysis). The processing operation may include demeaning the raw seismic data, applying bandpass filtering (e.g., between 5 to 200 Hz, to remove high and low frequency noise), performing structure-oriented median filtering (e.g., to remove high-amplitude erratic noise), performing curvelet denoising (e.g., to improve a signal-to-noise ratio (SNR)), performing frequency-wavenumber filtering, or any combination thereof.

FIG. 3 shows an example of a flow diagram 300 that supports tremor characterization for geothermal imaging in accordance with aspects of the present disclosure. The flow diagram 300 may implement or be implemented by various aspects of the geological zone 100. For example, the flow diagram 300 may represent a summed covariance method used for detection of a tremor event by a tremor characterization system, where seismic data based on which the summed covariance method may be performed may be collected from multiple receivers, such as the receivers 110 as described with reference to FIG. 1. Some operations of the flow diagram 300 may be performed in a different order than described or not performed at all. In some examples, operations may include additional features not mentioned below, or further operations may be added.

At 305, a tremor characterization system may generate a set of spectral representations. For example, the tremor characterization system may generate spectral representations of the seismic data for each receiver of multiple receivers distributed with reference to a geological zone. The tremor characterization system may generate the spectral representations based on processed data. For example, the tremor characterization system may generate the spectral representations after performing processing, which is described in greater detail with reference to FIG. 2. In some examples, the spectral representations may include spectrograms, and generation of the spectrograms may include calculating Fourier transforms on time-windowed segments of the seismic data (e.g., raw or processed seismic data). Additionally, or alternatively, the spectral representations may include scalograms, and the generation of the scalograms may include calculating wavelet transforms on time-windowed segments of the seismic data (e.g., raw or processed seismic data).

At 310, the tremor characterization system may process the spectral representations. For example, the tremor characterization system may perform mean removal (e.g., to remove hum, constant noise, etc.), detect and mask out impulsive signals, or both. As an example, the tremor characterization system may determine a short term average (STA) and a long term average (LTA) of each spectral representation. The tremor characterization system may detect variations in seismic signals based on the STA and the LTA, such as based on comparing the STA to the LTA. Additionally, or alternatively, the processing may include dividing each frequency component by a time average to suppress constant noise or suppressing impulsive signals through blurring, STA and LTA thresholding, and replacement of detections by values representative of background noise.

At 315, the tremor characterization system may calculate cross-spectra. For example, the tremor characterization system may calculate, for respective receiver pairs, a cross-spectrum. In other words, the tremor characterization system may generate multiple cross-spectra associated with respective pairings of receivers of the multiple receivers distributed with reference to the geological zone. After calculating the cross-spectra, the tremor characterization system may form a covariance matrix. The covariance matrix includes the cross-spectra between all station pairs.

After calculating the cross-spectra, at 320, the tremor characterization system may stack the cross-spectra. For example, the tremor characterization system may stack the cross-spectra of each receiver pair. Stacking the cross spectra may be referred to as calculating a sum of the covariance matrix. Additionally, or alternatively, stacking the cross-spectra may produce a time-frequency representation of the seismic data. In other words, the tremor characterization system may generate a time-frequency representation of the seismic data based on a sum of covariance matrices including the cross-spectra for each respective pair of the seismic receivers.

At 325, the tremor characterization system may calculate an average. For example, the tremor characterization system may determine an STA, an LTA, or both with respect to the sum of the covariance matrix. The tremor characterization system may identify variations in the signal, such as impulses, and remove some variations from the time-frequency representation of the seismic data.

At 330, the tremor characterization system may fit synthetic one or more models. For example, the tremor characterization system may compare multiple synthetic models to the sum of the covariance matrix. To compare the synthetic models to the sum of the covariance matrix, the tremor characterization system may generate multiple time slices from the sum of the covariance matrix. That is, the tremor characterization system may divide the summed covariance matrix into multiple time slices and compare respective time slices to the synthetic models. The synthetic models may be an example of synthetic resonance spectra, such as synthetic resonance spectra associated with different fundamental frequencies. In other words, the tremor characterization system may fit synthetic resonance spectra to the time-frequency representation of the processed seismic data on a per-time-instance basis.

At 335, the tremor characterization system may perform a manual review. For example, the tremor characterization system may identify a tremor event from the time-frequency representation fitted to the synthetic models. That is, the tremor characterization system may identify a subset of the seismic data based on the fitting, where the subset of the processed seismic data is representative of the tremor event. In some examples, the identification of the subset of the seismic data may be based on the manual review at 335. Additionally, or alternatively, the identification may be in accordance with the subset of the seismic data satisfying a threshold similarity to the synthetic resonance spectra.

In some examples, the identification may be based on classification of time-windowed segments of the seismic data. For example, the tremor characterization system may classify the time-windowed segments of the seismic data based on a computer vision or deep learning classifier trained on a catalog of real tremor events, synthetic tremor events, or both. The time-windowed segments may be an example of the multiple time slices of the time-frequency representation of the seismic data. Based on classifying the time-windowed segments, the tremor characterization system may identify the subset of the seismic data based on a classifier prediction.

FIG. 4 shows an example of a flow diagram 400-a that supports tremor characterization for geothermal imaging in accordance with aspects of the present disclosure. The flow diagram 400-a may implement or be implemented by various aspects of the geological zone 100. For example, the flow diagram 400-a may represent a cross-correlation method used for source location identification by a tremor characterization system, where seismic data based on which the cross-correlation method may be performed may be collected from multiple receivers, such as the receivers 110 as described with reference to FIG. 1. Some operations of the flow diagram 400-a may be performed in a different order than described or not performed at all. In some examples, operations may include additional features not mentioned below, or further operations may be added.

At 405, a tremor characterization system may calculate travel times. For example, the tremor characterization system may calculate travel times between respective receivers of multiple receivers of a geological zone and multiple points of a three-dimensional area within the geological zone. The receivers, geological zone, and the three-dimensional area may be examples of the receivers 110, the geological zone 100, and the three-dimensional area 115 as described with reference to FIG. 1. Additionally, the multiple points may be examples of points within different voxels, such as the voxel as described with reference to FIG. 1.

At 410, the tremor characterization system may calculate differential travel times. For example, the tremor characterization system may determine, for respective pairs of receivers of multiple receivers, a time shift based on the travel times. As an example, the tremor characterization system may determine a difference between a first travel time from a first point to a first receiver and a second travel time from the first point to a second receiver, the first travel time and a third travel time from the first point to a third receiver, and so on for each point of multiple points in the geological zone.

At 415, the tremor characterization system may calculate cross-correlation functions. For example, the tremor characterization system may calculate cross-correlation functions between respective receiver pairs. As an example, the tremor characterization system may calculate a cross-correlation function between a first receiver and a second receiver, where the cross-correlation function is based on the differential times between the first receiver and the second receiver for the multiple points in the geological zone.

At 420, the tremor characterization system may shift cross-correlation envelopes. For example, the tremor characterization system may shift the cross-correlation envelopes according to a velocity model. In some examples, the tremor characterization system may stack the cross-correlation envelopes after shifting.

At 425, the tremor characterization system may identify a set of locations (e.g., candidate locations). For example, the tremor characterization system may output one or more candidate locations representative of a source of the tremor event based on the cross-correlation function. The tremor characterization system may output the candidate locations based on a probability of the candidate locations to be the source of the tremor event, where the probability for a point is a sum of the cross-correlation envelopes for the point after shifting at 420 (e.g., at zero lag). In other words, the tremor characterization system may determine a probability of existence of the source tremor events for each of the points based on the cross-correlation function relative to a time shift difference between each pair of seismic receivers, where outputting the candidate locations is based on the probability.

FIG. 4B shows an example of a flow diagram 400-b that supports tremor characterization for geothermal imaging in accordance with aspects of the present disclosure. The flow diagram 400-b may implement or be implemented by various aspects of the geological zone 100. For example, the flow diagram 400-b may represent a beamforming method used for source location identification by a tremor characterization system, where seismic data based on which the beamforming method may be performed may be collected from multiple receivers, such as the receivers 110 as described with reference to FIG. 1. Some operations of the flow diagram 400-b may be performed in a different order than described or not performed at all. In some examples, operations may include additional features not mentioned below, or further operations may be added.

At 430, a tremor characterization system may calculate travel times. For example, the tremor characterization system may calculate travel times between respective receivers of multiple receivers of a geological zone and multiple points of a three-dimensional area within the geological zone. The receivers, geological zone, and the three-dimensional area may be examples of the receivers 110, the geological zone 100, and the three-dimensional area 115 as described with reference to FIG. 1. Additionally, the multiple points may be examples of points within different voxels, such as the voxel as described with reference to FIG. 1.

At 435, the tremor characterization system may calculate differential travel times. For example, the tremor characterization system may determine, for respective pairs of receivers of multiple receivers, a time shift based on the travel times. As an example, the tremor characterization system may determine a difference between a first travel time from a first point to a first receiver and a second travel time from the first point to a second receiver, the first travel time and a third travel time from the first point to a third receiver, and so on for each point of multiple points in the geological zone.

At 440, the tremor characterization system may perform beamforming. For example, the tremor characterization system may perform a back projection of waveforms relative to a time shift for each receiver. The back projection may also be referred to as a back propagation. The back projection may include calculating a beam Bⱼ for an imaging grid j at a time i. For example, the beam may be calculated according to Equation 1, where k is a receiver, N is a total quantity of receivers, T_{w} is a time window, τⱼₖ is a travel time for the imaging grid and the receiver, and w is a pre-processed waveform of a k-th receiver.

$${B}_{j} ( {t}_{i} ) = {\sum }_{k = 1}^{N} {w}_{k} ( {t}_{i} + {τ}_{j k} ) \qquad ( 1 )$$

After beams for the imaging grids are obtained, the power of the beam is calculated according to Equation 2 below, where

$${P}_{j}^{i}$$

is a power of a beam for the imaging grid j at the time i, 1. is a data point in the time window T_{w}, and M is a quantity of data points in the time window T_{w}.

$${P}_{j}^{i} = {\sum }_{l = 1}^{M} {B}_{j}^{i} ( {t}_{l} ) \qquad ( 2 )$$

The tremor characterization system may repeat the power calculation of Equation 2 over a time step Tₛ over a duration of deployment for the receivers. After the power calculation is repeated for the time step Tₛ, the back-projection is obtained for the geological zone. In other words, the tremor characterization system may generate a four-dimensional (e.g., three-dimensional in space, one-dimensional in time) back projection image. In some examples, the tremor characterization system may calculate an average power over a longer time window, such as for emergent tremor signals associated with longer durations. For example, the tremor characterization system may calculate the average power according to Equation 3 below, where Lis a quantity of time windows T_{w} in a relatively long time window Tₙ.

$$\underline{{P}_{j n}} = {\sum }_{j = 1}^{L} {P}_{j}^{i} \qquad ( 3 )$$

At 445, the tremor characterization system may identify locations. For example, the tremor characterization system may output one or more candidate locations representative of a source of the tremor event based on the back projection function. The tremor characterization system may determine a probability of existence of the source tremor events for each of the points based on the back projection of waveforms relative to the time shift difference for each seismic receiver, where outputting the candidate locations is based on the probability. For example, the tremor characterization system may generate a probability map based on the back projection of the waveforms.

FIG. 5 shows an example of a flow diagram 500-a that supports tremor

characterization for geothermal imaging in accordance with aspects of the present disclosure. The flow diagram 500-a may implement or be implemented by various aspects of the geological zone 100. For example, the flow diagram 500-a may represent an amplitude method used for source location identification by a tremor characterization system, where seismic data based on which the amplitude method may be performed, may be collected from multiple receivers, such as the receivers 110 as described with reference to FIG. 1. Some operations of the flow diagram 500-a may be performed in a different order than described or not performed at all. In some examples, operations may include additional features not mentioned below, or further operations may be added.

At 505, a tremor characterization system may determine an amplitude decay rate. For example, the tremor characterization system may determine an amplitude decay rate for pairs of receivers of multiple receivers of a geological zone, such as the geological zone 100 as described with reference to FIG. 1.

At 510, the tremor characterization system may determine a probability of existence of a source of a tremor event based on the amplitude decay rate. For example, the tremor characterization system may output candidate locations associated with the source of the tremor event based on the probability.

FIG. 5B shows an example of a flow diagram 500-b that supports tremor characterization for geothermal imaging in accordance with aspects of the present disclosure. The flow diagram 500-b may implement or be implemented by various aspects of the geological zone 100. For example, the flow diagram 500-b may represent an polarization method used for source location identification by a tremor characterization system, where seismic data based on which the polarization of particle motion method may be performed, may be collected from multiple receivers, such as the receivers 110 as described with reference to FIG. 1. Some operations of the flow diagram 500-b may be performed in a different order than described or not performed at all. In some examples, operations may include additional features not mentioned below, or further operations may be added.

At 515, a tremor characterization system may determine a cross-correlation function. For example, the tremor characterization system may determine the cross correlation function for pairs of receivers of multiple receivers of a geological zone, such as the geological zone 100 as described with reference to FIG. 1. Additionally, the tremor characterization system may determine the cross-correlation function for three components of each respective receiver, where the cross-correlation function is a three-component cross-correlation function.

At 520, the tremor characterization system may determine a dominant particle motion direction. For example, the tremor characterization system may determine the dominant particle motion direction based on the three-component cross-correlation function, where the dominant particle motion includes an azimuth angle and an incidence angle.

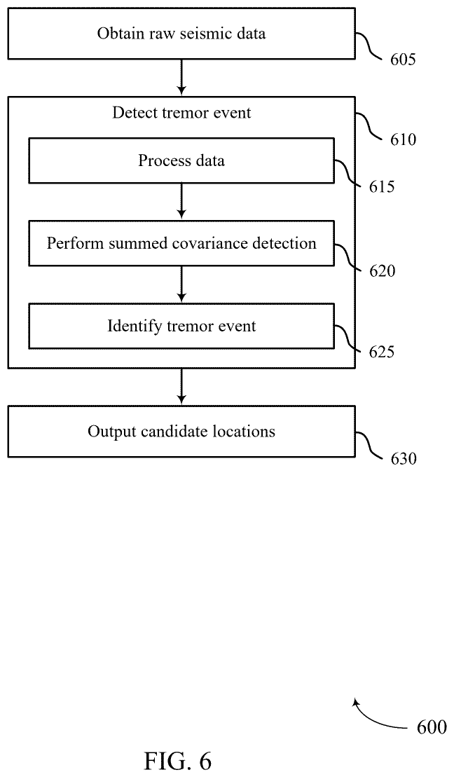

FIG. 6 shows an example of a flow diagram 600 that supports tremor characterization for geothermal imaging in accordance with aspects of the present disclosure. The flow diagram 600 may implement or be implemented by various aspects of the geological zone 100. For example, the flow diagram 600 may include processing, tremor event detection, and candidate location identification, where seismic data based on which the processing, detection, and identification may be performed may be collected from multiple receivers, such as the receivers 110 as described with reference to FIG. 1. Some operations of the flow diagram 600 may be performed in a different order than described or not performed at all. In some examples, operations may include additional features not mentioned below, or further operations may be added.

At 605, a tremor characterization system may obtain raw seismic data. For example, the tremor characterization system may obtain the raw seismic data from multiple seismic receivers distributed with reference to a geological zone. The seismic receivers and the geological zone may be examples of the receivers 110 and the geological zone 100, respectively, as described with reference to FIG. 1.

At 610, the tremor characterization system may detect a tremor event. To detect the tremor event, at 615, the tremor characterization system may process data. For example, the tremor characterization system may generate processed seismic data from the raw seismic data obtained at 605. The processing may be an example of the processing described with reference to FIG. 2.

At 620, the tremor characterization system may perform summed covariance detection. For example, the tremor characterization system may generate multiple spectral representations based on the raw or processed seismic data, generate covariance matrices for respective pairs of seismic receivers, generate a time-frequency representation (e.g., summed covariance matrix) of the processed seismic data, and fit a synthetic resonance spectra to the time-frequency representation. The summed covariance detection may be an example of the summed covariance method as described with reference to FIG. 3.

At 625, the tremor characterization system may identify a tremor event. For example, the tremor characterization system may identify a subset of the processed seismic data based on performing the summed covariance detection at 620, where the subset of the processed seismic data is representative of the tremor event.

At 630, the tremor characterization system may output candidate locations. For example, after detecting the tremor event, the tremor characterization system may output candidate locations representative of a source of the tremor event. The candidate locations may be output based on one or more of a cross-correlation function, a beamforming function, an amplitude function, or a polarization function as described with reference to FIGS. 4 and 5.

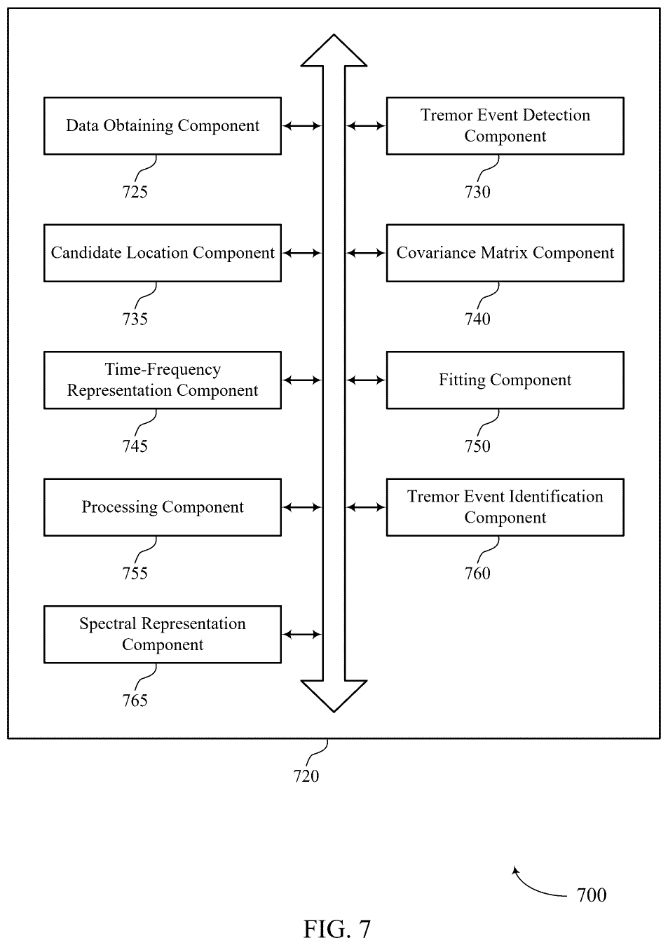

FIG. 7 shows a block diagram 700 of a Tremor Characterization System 720 that supports tremor characterization for geothermal imaging in accordance with aspects of the present disclosure. The Tremor Characterization System 720 may be an example of aspects of a Tremor Characterization System as described with reference to FIGS. 1 through 6. The Tremor Characterization System 720, or various components thereof, may be an example of means for performing various aspects of tremor characterization for geothermal imaging as described herein. For example, the Tremor Characterization System 720 may include a data obtaining component 725, a tremor event detection component 730, a candidate location component 735, a covariance matrix component 740, a time-frequency representation component 745 (e.g., supporting Fourier transforms or wavelet transforms), a fitting component 750, a processing component 755, a tremor event identification component 760, a spectral representation component 765 (e.g., supporting the sum of the covariance matrix), or any combination thereof. Each of these components, or components of subcomponents thereof (e.g., one or more processors, one or more memories), may communicate, directly or indirectly, with one another (e.g., via one or more buses).

The Tremor Characterization System 720 may support tremor characterization for geothermal reservoir imaging in accordance with examples as disclosed herein. In some examples, the tremor characterization system may also support, such as in addition to or alternatively from tremor characterization for geothermal imaging, carbon capture sites, subsurface injection sites, or one or more other locations where fractures and flow may generate tremor events. The data obtaining component 725 may be configured as or otherwise support a means for obtaining raw seismic data from a plurality of seismic receivers distributed with reference to a geological zone. The tremor event detection component 730 may be configured as or otherwise support a means for detecting a tremor event from the raw seismic data. In some examples, to the detecting, the processing component 755 may be configured as or otherwise support a means for generating processed seismic data from the raw seismic data, the spectral representation component 765 (e.g., supporting the sum of the covariance matrix) may be configured as or otherwise support a means for generating a plurality of spectral representations based at least in part on the raw seismic data or the processed seismic data, and the tremor event identification component 760 may be configured as or otherwise support a means for identifying a subset of the processed seismic data based at least in part on the plurality of spectral representations, wherein the subset of the processed seismic data is representative of the tremor event. The candidate location component 735 may be configured as or otherwise support a means for outputting, after detecting the tremor event, one or more candidate locations representative of a source of the tremor event.

In some examples, to support detecting the tremor event, the covariance matrix component 740 may be configured as or otherwise support a means for generating, for each respective pair of seismic receivers of the plurality of seismic receivers, a covariance matrix comprising cross-spectra between respective pairs of the plurality of spectral representations. In some examples, to support detecting the tremor event, the time-frequency representation component 745 (e.g., supporting Fourier transforms or wavelet transforms) may be configured as or otherwise support a means for generating a time-frequency representation of the processed seismic data based at least in part on a sum of the covariance matrix comprising the cross-spectra for each respective pair of the seismic receivers. In some examples, to support detecting the tremor event, the fitting component 750 may be configured as or otherwise support a means for fitting synthetic resonance spectra to the time-frequency representation of the processed seismic data on a per-time-instance basis, wherein identifying the subset of the processed seismic data is based at least in part on the fitting.

In some examples, identifying the subset of the processed seismic data based at least in part on the fitting is in accordance with the subset of the processed seismic data satisfying a threshold similarity to the synthetic resonance spectra.

In some examples, to support generating the time-frequency representation, the covariance matrix component 740 may be configured as or otherwise support a means for generating the covariance matrix based at least in part on calculation of, for each receiver pair of the plurality of seismic receivers, the cross-spectra between the receiver pairs. In some examples, to support generating the time-frequency representation, the time-frequency representation component 745 (e.g., supporting Fourier transforms or wavelet transforms) may be configured as or otherwise support a means for stacking the cross-spectra associated with each receiver pair, wherein the sum of the covariance matrix is based at least in part on the stacking.

In some examples, identifying the subset of the processed seismic data based at least in part on the fitting is in accordance with a manual selection of the subset of the processed seismic data.

In some examples, to support outputting the one or more candidate locations, the candidate location component 735 may be configured as or otherwise support a means for determining, for each respective pair of the seismic receivers of the plurality of seismic receivers, a time shift based at least in part on a plurality of seismic wave travel time durations between respective seismic receivers and a plurality of points of a three-dimensional area within the geological zone. In some examples, to support outputting the one or more candidate locations, the candidate location component 735 may be configured as or otherwise support a means for determining a probability of existence of the source of the tremor event at a plurality of locations distributed with reference to the geological zone based at least in part on a cross-correlation function relative to a time shift difference between each pair of seismic receivers, wherein outputting the one or more candidate locations is based at least in part on the probability.

In some examples, to support outputting the one or more candidate locations, the candidate location component 735 may be configured as or otherwise support a means for determining, for each respective pair of the seismic receivers of the plurality of seismic receivers, a time shift based at least in part on a plurality of seismic wave travel time durations between respective seismic receivers and a plurality of points of a three-dimensional area within the geological zone. In some examples, to support outputting the one or more candidate locations, the candidate location component 735 may be configured as or otherwise support a means for determining a probability of existence of the source of the tremor event at a plurality of locations distributed with reference to the geological zone based at least in part on a back projection of waveforms relative to the time shift for each seismic receiver, wherein outputting the one or more candidate locations based at least in part on the probability.

In some examples, to support outputting the one or more candidate locations, the candidate location component 735 may be configured as or otherwise support a means for determining, for each pair of seismic receivers of the plurality of seismic receivers, and for three-components of each respective seismic receiver, a three-component cross correlation function. In some examples, to support outputting the one or more candidate locations, the candidate location component 735 may be configured as or otherwise support a means for determining, for each seismic receiver of the plurality of seismic receivers and for each location within the geological zone for a plurality of time windows, a dominant particle motion direction based at least in part on a three-component cross-correlation function, the dominant particle motion direction comprising an azimuth angle and an incidence angle.

In some examples, to support outputting the one or more candidate locations, the candidate location component 735 may be configured as or otherwise support a means for determining, for each seismic receiver of the plurality of seismic receivers, an amplitude decay rate of a signal between each seismic receiver and a plurality of points of a three-dimensional area beneath the geological zone. In some examples, to support outputting the one or more candidate locations, the candidate location component 735 may be configured as or otherwise support a means for determining a probability of existence of the source of the tremor event at a plurality of locations distributed with reference to the geological zone based at least in part on the amplitude decay rate, wherein outputting the one or more candidate locations is based at least in part on the probability.

In some examples, the tremor event detection component 730 may be configured as or otherwise support a means for determining one or more characteristics of the tremor event at the one or more candidate locations based at least in part on a tremor-source physical model, the one or more characteristics comprising a geometric feature, a rock or fluid physical property feature, a flow rate, a fluid volume, or any combination thereof.

In some examples, to support generating the processed seismic data from the raw seismic data, the processing component 755 may be configured as or otherwise support a means for down-sampling the raw seismic data in accordance with a down-sampling ratio. In some examples, to support generating the processed seismic data from the raw seismic data, the processing component 755 may be configured as or otherwise support a means for generating a continuous segment of time-series data based at least in part on the down-sampled seismic data. In some examples, to support generating the processed seismic data from the raw seismic data, the processing component 755 may be configured as or otherwise support a means for generating a plurality of discrete segments of the time-series data from the continuous segment of the time-series data. In some examples, to support generating the processed seismic data from the raw seismic data, the processing component 755 may be configured as or otherwise support a means for generating demeaned or detrended seismic data for each of the plurality of discrete segments based at least in part on removal of a mean, a linear trend, or both from each of the plurality of discrete segments. In some examples, to support generating the processed seismic data from the raw seismic data, the processing component 755 may be configured as or otherwise support a means for generating the processed seismic data based at least in part on applying at least one of a bandpass filter, decimation, normalization, or any combination thereof, to the demeaned or detrended seismic data.

In some examples, the tremor event identification component 760 may be configured as or otherwise support a means for determining a STA and LTA of each of the plurality of spectral representations, wherein identifying the subset of the processed seismic data is based at least in part on a ratio of the STA to the LTA of each spectrogram.

In some examples, the generation of the plurality of spectral representations from the raw seismic data or the processed seismic data comprises calculating spectrograms based at least in part on Fourier transforms on time-windowed segments of the raw seismic data or the processed seismic data.

In some examples, the generation of the plurality of spectral representations from the raw seismic data or the processed seismic data comprises calculating scalograms based on wavelet transforms on time-windowed segments of the raw seismic data or the processed seismic data.

In some examples, the generation of the plurality of spectral representations comprises dividing each frequency component by a time average to suppress constant noise or suppressing impulsive signals through blurring, STA and LTA thresholding, and replacement of detections by values representative of background noise.

In some examples, DAS systems comprising a fiber optic cable and interrogator are used at each seismic receiver.

In some examples, to support detecting the tremor event from the plurality of spectral representations, the tremor event detection component 730 may be configured as or otherwise support a means for classifying time-windowed segments of the processed seismic data based at least in part on a computer vision or deep learning classifier trained on a catalog of real tremor events, synthetic tremor events, or both. In some examples, to support detecting the tremor event from the plurality of spectral representations, the tremor event detection component 730 may be configured as or otherwise support a means for identifying the subset of the processed seismic data based at least in part on a classifier prediction, wherein the subset of the processed seismic data is representative of the tremor event.

In some examples, identifying the subset of the processed seismic data representative of the tremor event is further based at least in part on the subset of the processed seismic data comprising a duration characteristic of the tremor event, a frequency characteristic of the tremor event, one or more spectral peaks characteristic of the tremor event, an absence of arrival times of one or more waves, or any combination thereof.

In some examples, the plurality of seismic receivers comprise a network of seismic receivers or an array of seismic receivers.

In some examples, the spectral representation component 765 (e.g., supporting the sum of the covariance matrix) may be configured as or otherwise support a means for generating a plurality of de-noised spectral representations based at least in part on the plurality of spectral representations, wherein generating the covariance matrix is based at least in part on the plurality of de-noised spectral representations.

In some examples, the one or more candidate locations are used as a representative of the source of the tremor event to identify drilling locations of new wells, to optimize wellfield design and utilization, or to update models of a subsurface reservoir. Additionally, or alternatively, the Tremor Characterization System 720 may support generating an interpretive subsurface image, or refining a reservoir model, or selecting well target locations based on the presence, location, or physical interpretation of tremor events detected in the subsurface.

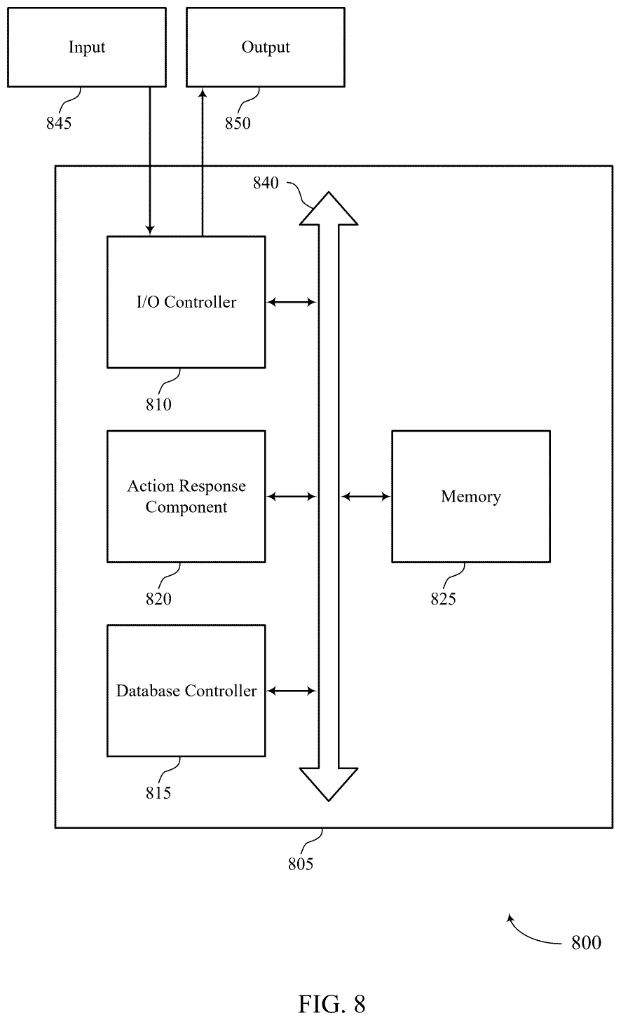

FIG. 8 shows a diagram of a system 800 including a device 805 that supports tremor characterization for geothermal imaging in accordance with aspects of the present disclosure. The device 805 may include components for bi-directional voice and data communications including components for transmitting and receiving communications, such as an action response component 820, an I/O controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor. In some examples, a user may interact with the device 805 via the I/O controller 810 or via hardware components controlled by the I/O controller 810.

The database controller 815 may manage data storage and processing in a database 835. The database 835 may be external to the device 805, temporarily or permanently connected to the device 805, or a data storage component of the device 805. In some cases, a user may interact with the database controller 815. In some other cases, the database controller 815 may operate automatically without user interaction. The database 835 may be an example of a persistent data store, a single database, a distributed database, multiple distributed databases, a database management system, or an emergency backup database.

Memory 825 may include random-access memory (RAM) and ROM. The memory 825 may store computer-readable, computer-executable software including instructions that, when executed, cause the processor to perform various functions described herein. In some cases, the memory 825 may contain, among other things, a BIOS which may control basic hardware or software operation such as the interaction with peripheral components or devices.

The processor 830 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 830 may be configured to operate a memory array using a memory controller. In some other cases, a memory controller may be integrated into the processor 830. The processor 830 may be configured to execute computer-readable instructions stored in memory 825 to perform various functions (e.g., functions or tasks supporting tremor characterization for geothermal imaging).

The action response component 820 may support tremor characterization for geothermal reservoir imaging in accordance with examples as disclosed herein. For example, the action response component 820 may be configured as or otherwise support a means for obtaining raw seismic data from a plurality of seismic receivers distributed with reference to a geological zone. The action response component 820 may be configured as or otherwise support a means for detecting a tremor event from the raw seismic data. In some examples, to the detecting, the action response component 820 may be configured as or otherwise support a means for generating processed seismic data from the raw seismic data, generating a plurality of spectral representations based at least in part on the raw seismic data or the processed seismic data, and identifying a subset of the processed seismic data based at least in part on the plurality of spectral representations, wherein the subset of the processed seismic data is representative of the tremor event. The action response component 820 may be configured as or otherwise support a means for outputting, after detecting the tremor event, one or more candidate locations representative of a source of the tremor event.

By including or configuring the action response component 820 in accordance with examples as described herein, the device 805 may support techniques for improved tremor detection and imaging.

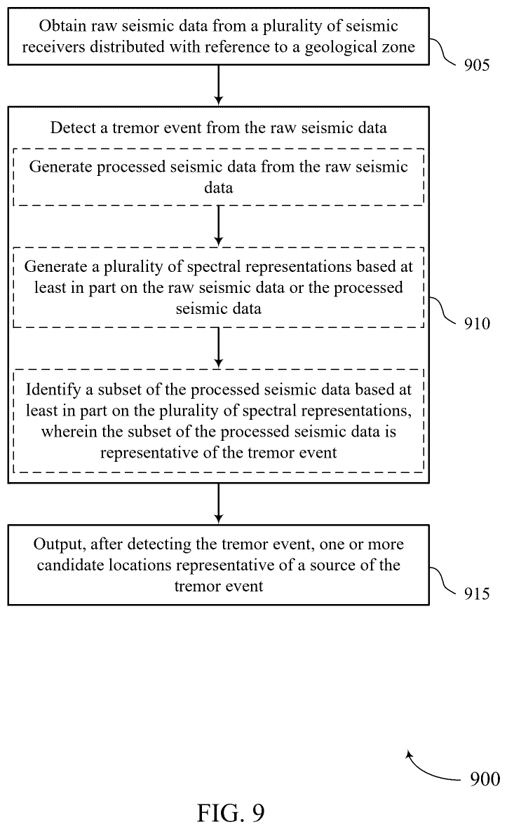

FIG. 9 shows a flowchart illustrating a method 900 that supports tremor characterization for geothermal imaging in accordance with aspects of the present disclosure. The operations of the method 900 may be implemented by a Tremor Characterization System or its components as described herein. For example, the operations of the method 900 may be performed by a Tremor Characterization System as described with reference to FIGS. 1 through 8. In some examples, a Tremor Characterization System may execute a set of instructions to control the functional elements of the Tremor Characterization System to perform the described functions. Additionally, or alternatively, the Tremor Characterization System may perform aspects of the described functions using special-purpose hardware.

At 905, the method may include obtaining raw seismic data from a plurality of seismic receivers distributed with reference to a geological zone. The operations of 905 may be performed in accordance with examples as disclosed herein. In some examples, aspects of the operations of 905 may be performed by a data obtaining component 725 as described with reference to FIG. 7.

At 910, the method may include detecting a tremor event from the raw seismic data. In some examples, the detecting may include generating processed seismic data from the raw seismic data, generating a plurality of spectral representations based at least in part on the raw seismic data or the processed seismic data, and identifying a subset of the processed seismic data based at least in part on the plurality of spectral representations, wherein the subset of the processed seismic data is representative of the tremor event. The operations of 910 may be performed in accordance with examples as disclosed herein. In some examples, aspects of the operations of 910 may be performed by a tremor event detection component 730 as described with reference to FIG. 7.

At 915, the method may include outputting, after detecting the tremor event, one or more candidate locations representative of a source of the tremor event. The operations of 915 may be performed in accordance with examples as disclosed herein. In some examples, aspects of the operations of 915 may be performed by a candidate location component 735 as described with reference to FIG. 7.

In some examples, an apparatus as described herein may perform a method or methods, such as the method 900. The apparatus may include features, circuitry, logic, means, or instructions (e.g., a non-transitory computer-readable medium storing instructions executable by a processor) for obtaining raw seismic data from a plurality of seismic receivers distributed with reference to a geological zone, detecting a tremor event from the raw seismic data, wherein the detecting comprises generating processed seismic data from the raw seismic data, generating a plurality of spectral representations based at least in part on the raw seismic data or the processed seismic data, and identifying a subset of the processed seismic data based at least in part on the plurality of spectral representations, wherein the subset of the processed seismic data is representative of the tremor event, and outputting, after detecting the tremor event, one or more candidate locations representative of a source of the tremor event.

In some examples of the method 900 and the apparatus described herein, detecting the tremor event may include operations, features, circuitry, logic, means, or instructions for generating, for each respective pair of seismic receivers of the plurality of seismic receivers, a covariance matrix comprising cross-spectra between respective pairs of the plurality of spectral representations, generating a time-frequency representation of the processed seismic data based at least in part on a sum of the covariance matrix comprising the cross-spectra for each respective pair of the seismic receivers, and fitting synthetic resonance spectra to the time-frequency representation of the processed seismic data on a per-time-instance basis, wherein identifying the subset of the processed seismic data may be based at least in part on the fitting.

Some examples of the method 900 and the apparatus described herein may further include operations, features, means, or instructions for identifying the subset of the processed seismic data based at least in part on the fitting may be in accordance with the subset of the processed seismic data satisfying a threshold similarity to the synthetic resonance spectra.

In some examples of the method 900 and the apparatus described herein, generating the time-frequency representation may include operations, features, circuitry, logic, means, or instructions for generating the covariance matrix based at least in part on calculation of, for each receiver pair of the plurality of seismic receivers, the cross-spectra between the receiver pairs and stacking the cross-spectra associated with each receiver pair, wherein the sum of the covariance matrix may be based at least in part on the stacking.

Some examples of the method 900 and the apparatus described herein may further include operations, features, means, or instructions for identifying the subset of the processed seismic data based at least in part on the fitting may be in accordance with a manual selection of the subset of the processed seismic data.

In some examples of the method 900 and the apparatus described herein, outputting the one or more candidate locations may include operations, features, circuitry, logic, means, or instructions for determining, for each respective pair of the seismic receivers of the plurality of seismic receivers, a time shift based at least in part on a plurality of seismic wave travel time durations between respective seismic receivers and a plurality of points of a three-dimensional area within the geological zone and determining a probability of existence of the source of the tremor event at a plurality of locations distributed with reference to the geological zone based at least in part on a cross-correlation function relative to a time shift difference between each pair of seismic receivers, wherein outputting the one or more candidate locations may be based at least in part on the probability.

In some examples of the method 900 and the apparatus described herein, outputting the one or more candidate locations may include operations, features, circuitry, logic, means, or instructions for determining, for each respective pair of the seismic receivers of the plurality of seismic receivers, a time shift based at least in part on a plurality of seismic wave travel time durations between respective seismic receivers and a plurality of points of a three-dimensional area within the geological zone and determining a probability of existence of the source of the tremor event at a plurality of locations distributed with reference to the geological zone based at least in part on a back projection of waveforms relative to the time shift for each seismic receiver, wherein outputting the one or more candidate locations based at least in part on the probability.

In some examples of the method 900 and the apparatus described herein, outputting the one or more candidate locations may include operations, features, circuitry, logic, means, or instructions for determining, for each pair of seismic receivers of the plurality of seismic receivers, and for three-components of each respective seismic receiver, a three-component cross correlation function and determining, for each seismic receiver of the plurality of seismic receivers and for each location within the geological zone for a plurality of time windows, a dominant particle motion direction based at least in part on a three-component cross-correlation function, the dominant particle motion direction comprising an azimuth angle and an incidence angle.

In some examples of the method 900 and the apparatus described herein, outputting the one or more candidate locations may include operations, features, circuitry, logic, means, or instructions for determining, for each seismic receiver of the plurality of seismic receivers, an amplitude decay rate of a signal between each seismic receiver and a plurality of points of a three-dimensional area beneath the geological zone and determining a probability of existence of the source of the tremor event at a plurality of locations distributed with reference to the geological zone based at least in part on the amplitude decay rate, wherein outputting the one or more candidate locations may be based at least in part on the probability.

Some examples of the method 900 and the apparatus described herein may further include operations, features, means, or instructions for determining one or more characteristics of the tremor event at the one or more candidate locations based at least in part on a tremor-source physical model, the one or more characteristics comprising a geometric feature, a rock or fluid physical property feature, a flow rate, a fluid volume, or any combination thereof.

In some examples of the method 900 and the apparatus described herein, generating the processed seismic data from the raw seismic data may include operations, features, circuitry, logic, means, or instructions for down-sampling the raw seismic data in accordance with a down-sampling ratio, generating a continuous segment of time-series data based at least in part on the down-sampled seismic data, generating a plurality of discrete segments of the time-series data from the continuous segment of the time-series data, generating demeaned or detrended seismic data for each of the plurality of discrete segments based at least in part on removal of a mean, a linear trend, or both from each of the plurality of discrete segments, and generating the processed seismic data based at least in part on applying at least one of a bandpass filter, decimation, normalization, or any combination thereof, to the demeaned or detrended seismic data.

Some examples of the method 900 and the apparatus described herein may further include operations, features, means, or instructions for determining a STA and LTA of each of the plurality of spectral representations, wherein identifying the subset of the processed seismic data may be based at least in part on a ratio of the STA to the LTA of each spectrogram.

In some examples of the method 900 and the apparatus described herein, the generation of the plurality of spectral representations from the raw seismic data or the processed seismic data comprises calculating spectrograms based at least in part on Fourier transforms on time-windowed segments of the raw seismic data or the processed seismic data.

In some examples of the method 900 and the apparatus described herein, the generation of the plurality of spectral representations from the raw seismic data or the processed seismic data comprises calculating scalograms based on wavelet transforms on time-windowed segments of the raw seismic data or the processed seismic data.

In some examples of the method 900 and the apparatus described herein, the generation of the plurality of spectral representations comprises dividing each frequency component by a time average to suppress constant noise or suppressing impulsive signals through blurring, STA and LTA thresholding, and replacement of detections by values representative of background noise.

Some examples of the method 900 and the apparatus described herein may further include operations, features, means, or instructions for DAS systems comprising a fiber optic cable and interrogator may be used at each seismic receiver.

In some examples of the method 900 and the apparatus described herein, detecting the tremor event from the plurality of spectral representations may include operations, features, circuitry, logic, means, or instructions for classifying time-windowed segments of the processed seismic data based at least in part on a computer vision or deep learning classifier trained on a catalog of real tremor events, synthetic tremor events, or both and identifying the subset of the processed seismic data based at least in part on a classifier prediction, wherein the subset of the processed seismic data may be representative of the tremor event.

Some examples of the method 900 and the apparatus described herein may further include operations, features, means, or instructions for identifying the subset of the processed seismic data representative of the tremor event may be further based at least in part on the subset of the processed seismic data comprising a duration characteristic of the tremor event, a frequency characteristic of the tremor event, one or more spectral peaks characteristic of the tremor event, an absence of arrival times of one or more waves, or any combination thereof.

In some examples of the method 900 and the apparatus described herein, the plurality of seismic receivers comprise a network of seismic receivers or an array of seismic receivers.

Some examples of the method 900 and the apparatus described herein may further include operations, features, means, or instructions for generating a plurality of de-noised spectral representations based at least in part on the plurality of spectral representations, wherein generating the covariance matrix may be based at least in part on the plurality of de-noised spectral representations.

In some examples of the method 900 and the apparatus described herein, the one or more candidate locations may be used as a representative of the source of the tremor event to identify drilling locations of new wells, to optimize wellfield design and utilization, or to update models of a subsurface reservoir.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for tremor characterization for geothermal reservoir imaging, comprising:
obtaining raw seismic data from a plurality of seismic receivers distributed with reference to a geological zone;
detecting a tremor event from the raw seismic data, wherein the detecting comprises:
generating processed seismic data from the raw seismic data;
generating a plurality of spectral representations based at least in part on the raw seismic data or the processed seismic data;
identifying a subset of the processed seismic data based at least in part on the plurality of spectral representations, wherein the subset of the processed seismic data is representative of the tremor event; and
outputting, after detecting the tremor event, one or more candidate locations representative of a source of the tremor event.

2. The method of claim 1, wherein detecting the tremor event further comprises:
generating, for each respective pair of seismic receivers of the plurality of seismic receivers, a covariance matrix comprising cross-spectra between respective pairs of the plurality of spectral representations;
generating a time-frequency representation of the processed seismic data based at least in part on a sum of the covariance matrix comprising the cross-spectra for each respective pair of the seismic receivers; and
fitting synthetic resonance spectra to the time-frequency representation of the processed seismic data on a per-time-instance basis, wherein identifying the subset of the processed seismic data is based at least in part on the fitting.

3. The method of claim 2, wherein identifying the subset of the processed seismic data based at least in part on the fitting is in accordance with the subset of the processed seismic data satisfying a threshold similarity to the synthetic resonance spectra.

4. The method of claim 2, wherein generating the time-frequency representation further comprises:
generating the covariance matrix based at least in part on calculation of, for each receiver pair of the plurality of seismic receivers, the cross-spectra between the receiver pairs; and
stacking the cross-spectra associated with each receiver pair, wherein the sum of the covariance matrix is based at least in part on the stacking.

5. The method of claim 2, wherein identifying the subset of the processed seismic data based at least in part on the fitting is in accordance with a manual selection of the subset of the processed seismic data.

6. The method of claim 1, wherein outputting the one or more candidate locations comprises:
determining, for each respective pair of the seismic receivers of the plurality of seismic receivers, a time shift based at least in part on a plurality of seismic wave travel time durations between respective seismic receivers and a plurality of points of a three-dimensional area within the geological zone; and
determining a probability of existence of the source of the tremor event at a plurality of locations distributed with reference to the geological zone based at least in part on a cross-correlation function relative to a time shift difference between each pair of seismic receivers, wherein outputting the one or more candidate locations is based at least in part on the probability.

7. The method of claim 1, wherein outputting the one or more candidate locations comprises:
determining, for each respective pair of the seismic receivers of the plurality of seismic receivers, a time shift based at least in part on a plurality of seismic wave travel time durations between respective seismic receivers and a plurality of points of a three-dimensional area within the geological zone; and
determining a probability of existence of the source of the tremor event at a plurality of locations distributed with reference to the geological zone based at least in part on a back projection of waveforms relative to the time shift for each seismic receiver, wherein outputting the one or more candidate locations based at least in part on the probability.

8. The method of claim 1, wherein outputting the one or more candidate locations comprises:
determining, for each pair of seismic receivers of the plurality of seismic receivers, and for three-components of each respective seismic receiver, a three-component cross correlation function; and
determining, for each seismic receiver of the plurality of seismic receivers and for each location within the geological zone for a plurality of time windows, a dominant particle motion direction based at least in part on a three-component cross-correlation function, the dominant particle motion direction comprising an azimuth angle and an incidence angle.

9. The method of claim 1, wherein outputting the one or more candidate locations comprises:
determining, for each seismic receiver of the plurality of seismic receivers, an amplitude decay rate of a signal between each seismic receiver and a plurality of points of a three-dimensional area beneath the geological zone; and
determining a probability of existence of the source of the tremor event at a plurality of locations distributed with reference to the geological zone based at least in part on the amplitude decay rate, wherein outputting the one or more candidate locations is based at least in part on the probability.

10. The method of claim 1, further comprising:
determining one or more characteristics of the tremor event at the one or more candidate locations based at least in part on a tremor-source physical model, the one or more characteristics comprising a geometric feature, a rock or fluid physical property feature, a flow rate, a fluid volume, or any combination thereof.

11. The method of claim 1, wherein generating the processed seismic data from the raw seismic data comprises:
down-sampling the raw seismic data in accordance with a down-sampling ratio;
generating a continuous segment of time-series data based at least in part on the down-sampled seismic data;
generating a plurality of discrete segments of the time-series data from the continuous segment of the time-series data;
generating demeaned or detrended seismic data for each of the plurality of discrete segments based at least in part on removal of a mean, a linear trend, or both from each of the plurality of discrete segments; and
generating the processed seismic data based at least in part on applying at least one of a bandpass filter, decimation, normalization, or any combination thereof, to the demeaned or detrended seismic data.

12. The method of claim 1, further comprising:
determining a short term average (STA) and long term average (LTA) of each of the plurality of spectral representations, wherein identifying the subset of the processed seismic data is based at least in part on a ratio of the STA to the LTA of each spectrogram.

13. The method of claim 1, wherein the generation of the plurality of spectral representations from the raw seismic data or the processed seismic data comprises calculating spectrograms based at least in part on Fourier transforms on time-windowed segments of the raw seismic data or the processed seismic data.

14. The method of claim 1, wherein the generation of the plurality of spectral representations from the raw seismic data or the processed seismic data comprises calculating scalograms based on wavelet transforms on time-windowed segments of the raw seismic data or the processed seismic data.

15. The method of claim 1, wherein the generation of the plurality of spectral representations comprises dividing each frequency component by a time average to suppress constant noise or suppressing impulsive signals through blurring, short term average (STA) and long term average (LTA) thresholding, and replacement of detections by values representative of background noise.

16. The method of claim 1, wherein distributed acoustic sensing (DAS) systems comprising a fiber optic cable and interrogator are used at each seismic receiver.

17. The method of claim 1, wherein detecting the tremor event from the plurality of spectral representations comprises:
classifying time-windowed segments of the processed seismic data based at least in part on a computer vision or deep learning classifier trained on a catalog of real tremor events, synthetic tremor events, or both; and
identifying the subset of the processed seismic data based at least in part on a classifier prediction, wherein the subset of the processed seismic data is representative of the tremor event.

18. The method of claim 1, wherein identifying the subset of the processed seismic data representative of the tremor event is further based at least in part on the subset of the processed seismic data comprising a duration characteristic of the tremor event, a frequency characteristic of the tremor event, one or more spectral peaks characteristic of the tremor event, an absence of arrival times of one or more waves, or any combination thereof.

19. An apparatus for tremor characterization for geothermal reservoir imaging, comprising:
one or more memories storing processor-executable code; and
one or more processors coupled with the one or more memories and individually or collectively operable to execute the code to cause the apparatus to:
obtain raw seismic data from a plurality of seismic receivers distributed with reference to a geological zone;
detect a tremor event from the raw seismic data, wherein, to the detecting, the one or more processors are individually or collectively operable to execute the code to cause the apparatus to:
generate processed seismic data from the raw seismic data;
generate a plurality of spectral representations based at least in part on the raw seismic data or the processed seismic data;
identify a subset of the processed seismic data based at least in part on the plurality of spectral representations, wherein the subset of the processed seismic data is representative of the tremor event; and
output, after detecting the tremor event, one or more candidate locations representative of a source of the tremor event.

20. A non-transitory computer-readable medium storing code for tremor characterization for geothermal reservoir imaging, the code comprising instructions executable by one or more processors to:
obtain raw seismic data from a plurality of seismic receivers distributed with reference to a geological zone;
detect a tremor event from the raw seismic data, wherein the instructions to the detecting are executable to:
generate processed seismic data from the raw seismic data;
generate a plurality of spectral representations based at least in part on the raw seismic data or the processed seismic data;
identify a subset of the processed seismic data based at least in part on the plurality of spectral representations, wherein the subset of the processed seismic data is representative of the tremor event; and
output, after detecting the tremor event, one or more candidate locations representative of a source of the tremor event.
